(19) United States
(12) Patent Application Publication
(10) Pub. No.: US 2013/0066773 A1
(43) Pub. Date: Mar. 14, 2013

(54) INTELLIGENT ADMINISTRATION SYSTEM FOR PAYING ELECTRIC BILL

(71) Applicants: Yu-Tzu Chou, Taipei (TW); Shiue-Juan Liao, Taipei (TW); Wun-Sheng Li, Taipei (TW)

(72) Inventors: Yu-Tzu Chou, Taipei (TW); Shiue-Juan Liao, Taipei (TW); Wun-Sheng Li, Taipei (TW)

(73) Assignee: CHUNGHWA TELECOM CO., LTD., Taipei (TW)

(21) Appl. No.: 13/344,053

(22) Filed: Jan. 5, 2012

(30) Foreign Application Priority Data
Sep. 14, 2011 (TW) 100132957

(51) Int. Cl. G06Q 20/14; G01R 21/133

(52) U.S. Cl. 705/40; 705/412

(57) ABSTRACT

An intelligent administration system for paying electricity bills mainly includes a monitoring device for monitoring the actual meter readings that indicate the electricity consumption of an electricity consuming system and a management platform connected to the monitoring device via a network system. Accordingly, the intelligent administration system for paying electricity bills of the present invention allows real-time monitoring of the electricity consuming system, provides remote value-adding and payments, and allows the administrator to adjust electricity charging standard according to the fluctuations in tariff, achieving a fair payment mechanism.

### FIELD OF THE INVENTION

The present invention relates to intelligent administration systems for paying electricity bills, and more particularly, to an intelligent administration system for paying electricity bills that allow remote management.

### BACKGROUND OF THE INVENTION

It is well known that household electricity is typically obtained from power plants by converting energy source such as nuclear power, fire, water or wind to electric energy, which is delivered, through cables, substations, power distribution equipments within communities or buildings, and wires, to plugs in houses. In general, each family or company is equipped with an electricity meter that records the electricity consumption therein by such as air-conditioning, illumination, electric water heaters, computers and other electrical equipments. In some special cases, such as student or staff dormitory, there normally are several rooms in a floor for individual student or employee, and thus the electricity consumptions differ between the rooms. For the convenience and fairness of calculating electricity utilization cost, colleges or companies usually install a separate meter outside each of the rooms to individually calculate the electricity consumptions. When electricity bills are to be collected, the colleges or companies then write down each reading of the meters to calculate electricity utilization cost for the individual room.

Such manual copying the meter reading is time consuming and disputable, and in the event of a user being unable or deliberately delaying to pay the bill, there is no effective way to supervising the electricity utilization, especially for student or staff dormitory. It becomes a main issue to provide a united management of electricity so as to achieve the goal of “user pays”. A known technique provides an electricity management device and stored value cards (SVC), and this electricity management device is typically placed on an electrical equipment, e.g. an air conditioner, for which is managed. Users should first add values in their SVC at a designated administration site. At the site, the allowable amount of electricity utilization (e.g., in certain value or electric power unit) is written into the cards. When the user wishes to turn on the air conditioner, he or she needs to insert the SVC into a card reader of the electricity management device. Thereafter, the air conditioner is activated and runs according to the available amount written in the card. When the allowable amounts run out, the users need to go to the administration site adding values into their SVC again.

Although the aforementioned technique is capable of managing the elapsed time of using certain electrical equipments, whole electricity consumption in a dormitory or building is difficult to control, and the users can only pay for the electricity utilization without a fair and transparent payment mechanism. In addition, the electricity tariffs announced by the power company usually depend on seasons during a year, such that there is a need for effectively and supervising electricity utilization at demand side according to the floating electricity tariffs.

### SUMMARY OF THE INVENTION

In view of the above problems of the prior art, the present invention provides an intelligent administration system for paying electricity bills that provides real-time supervisory and management for using electricity of an electricity consumption system.

The intelligent administration system for paying electricity bills according to the present invention comprises: a management platform, including: a tariff information module for setting electricity tariff information; an electricity utilization preset module for presetting a predefined electricity utilization cost for using an electricity consuming system; and a transmission module for outputting the electricity tariff information and the predefined electricity utilization cost; and a monitoring device for receiving the electricity tariff information and the predefined electricity utilization cost, and for monitoring actual meter readings indicating electricity consumption of the electricity consuming system to calculate an actual electricity utilization cost based on the electricity tariff information, and to thereby deactivate the electricity consuming system when the actual electricity utilization cost matches the predefined electricity utilization cost.

The management platform of the intelligent administration system for paying electricity bills of the present invention allows the electricity tariff information to be set, including a current electricity tariff or a tariff charging standard. The current electricity tariff is the electricity tariff announced by the power company, and the tariff charging standard indicates different charging criteria set by the administrator at different times. As such, the administrator is able to set the electricity tariff information using the tariff information module and adjust the charging standards in accordance with the current electricity tariff floating, providing a transparent billing mechanism. In addition, the users are allowed to login the management platform via such as the Internet to preset the predefined electricity utilization cost; that is, the users themselves can control the electricity utilization status of the electricity consuming system in advance.

In addition, the management platform of the intelligent administration system for paying electricity bills of the present invention further includes a paying module for allowing the user to login to the management platform and pay for the predefined electricity utilization cost, such as Internet banking, Internet ATM, stored value cards (SVCs), online debit/credit cards and the likes.

Moreover, the management platform of the intelligent administration system for paying electricity bills of the present invention further includes a database and an analysis module. The analysis module performs analysis on the electricity tariff information, the actual meter readings, the actual electricity utilization cost or the predefined electricity utilization cost in the database.

Furthermore, the management platform of the intelligent administration system for paying electricity bills of the present invention further includes an alerting module (e.g. a text message, a voice message or an electronic mail) for sending out an alerting message when there is abnormality in the electricity utilization status of the electricity consuming system or the actual electricity utilization cost exceeds the predefined electricity utilization cost.

Compared to the prior art, the intelligent administration system for paying electricity bills of the present invention not only allows real-time monitoring of electricity consuming system and setting of charging standard, but also allows presetting of predefined electricity utilization cost and remote payment, and sending of an alert message when the actual electricity utilization cost approaches the predefined electricity utilization cost, assisting supervisory and management of electricity utilization.

### BRIEF DESCRIPTION OF THE DRAWINGS

FIG. 1 is a block diagram showing a basic structure according to an embodiment of an intelligent administration system for paying electricity bills of the present invention; and

FIG. 2 is a block diagram showing an embodiment of the intelligent administration system for paying electricity bills of the present invention.

### DETAILED DESCRIPTION OF THE EMBODIMENTS

The present invention is described by the following specific embodiments. Those with ordinary skill in the arts can readily understand the other advantages and functions of the present invention after reading the disclosure of this specification. The present invention can also be implemented with different embodiments. Various details described in this specification can be modified based on different viewpoints and applications without departing from the scope of the present invention.

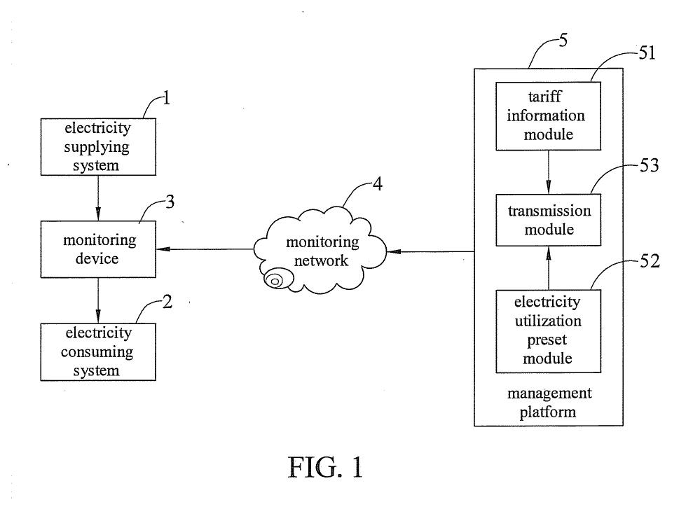

Referring to FIG. 1, an intelligent administration system for paying electricity bills according to the present invention provides to an electricity supplying system 1 a way to manage the electricity of an electricity consuming system 2. The intelligent administration system for paying electricity bills includes a monitoring device 3 and a management platform 5 connected to the monitoring device 3 via a network system 4.

The monitoring device 3 is used to monitor the electricity provided from the electricity supplying system 1 to the electricity consuming system 2, and obtain the actual meter reading of the electricity consuming system 2. Typically, a household is usually provided with an electrical meter for display electricity utilization of the electricity consuming system within the household. As for students or staff quarters, a separate meter is provided for each of rooms to independently indicate the electricity utilization of the electricity consuming system within the room. Reading of the meter is automatically obtained by connecting the monitoring device 3 to the meter, so as to know the exact electricity utilization status of the electricity consuming system in each of the rooms.

The management platform 5 includes a tariff information module 51, an electricity utilization preset module 52, and a transmission module 53.

The tariff information module 51 allows the electricity tariff information to be set, including the current electricity tariff or tariff charging standard. The current electricity tariff varies on the season basis, such as summer and winter electricity rates are not the same. This is the current electricity tariff announced by the company, and a administrator can use tariff information module 51 to set the current electricity tariff. An electricity charging standard is a billing criterion set by the administrator (i.e., the intelligent administration system), such as electricity per unit at daytime is different from that at nighttime, or electricity per unit during summer is different from that during a semester, or even different billing method between different quarters, thereby the administrator can adjust billing using the tariff information module 51.

The electricity utilization preset module 52 is used to preset a predefined electricity utilization cost in the electricity consuming system 2. More particularly, the user can login the management platform 5 to preset an available predefined electricity utilization cost to in advance manage and control the status of electricity utilization.

The transmission module 53 can transmit the electricity tariff information and the predefined electricity utilization cost available to the monitoring device 3 via the network system 4, so that the monitoring device 3 can calculate the actual electricity utilization cost for using the electricity consuming system 2 based on the electricity tariff information, and when this actual electricity utilization cost matches the predefined electricity utilization cost, the monitoring device 3 terminates the electricity utilization of the electricity consuming system 2.

Therefore, the tariff information module 51 of the management platform 5 allows the administrator to login to the management platform 5 via the Internet to set the electricity tariff information, and the electricity utilization preset module 52 allows the user to login to the management platform 5 via the Internet to preset the predefined electricity utilization, so that the intelligent administration system for paying electricity bills of the present invention can adjust the billing method and carry out the “user-pays” mechanism.

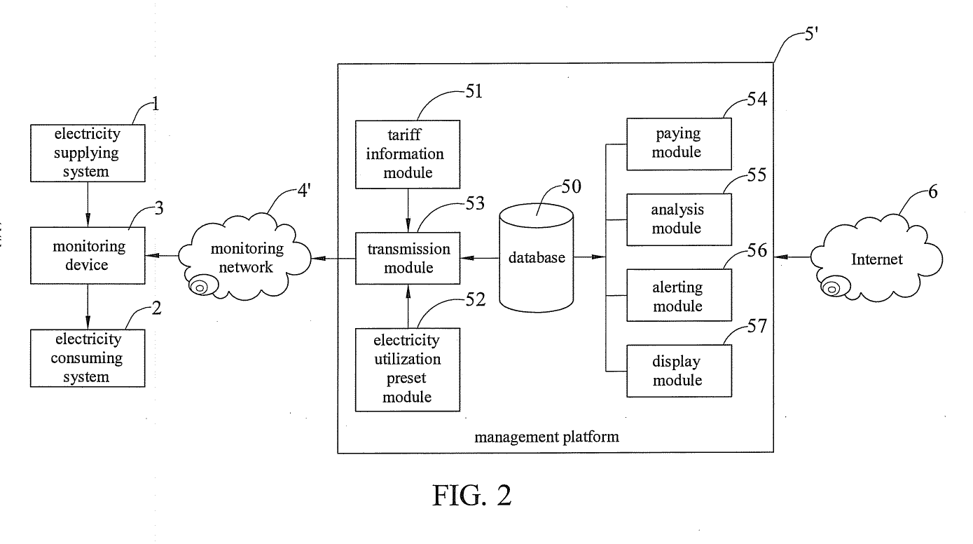

Referring to FIG. 2, a management platform 5′ may further include a database 50, a paying module 54, an analysis module 55, an alerting module 56 and a display module 57.

The paying module 54 allows the user to login to the electricity utilization management platform 5′ via the Internet 6 and pay the bill according to the predefined electricity utilization cost. Compared to the prior art where a specialized administrator has to be provided to manage the electricity utilization of users or assist in topping up, and the users have no control over their own electricity utilization and cannot pay their own bills which is not only labor wasting but also quite troublesome for the users, the electricity utilization preset module 52 and the paying module 54 in the management platform 5′ of the intelligent administration system for paying electricity bills of the present invention allow users to login to the management platform 5′ via the Internet 6, and preset their own predefined electricity utilization cost online. In addition, the paying module 54 allows the users to pay via by IC cards such as through Internet banking, Internet ATM, top-top cards, credit cards and so on. In other words, as an embodiment, the user is able to prepay the electricity bill for money deduction as the electricity utilization, through the intelligent administration system for paying electricity bills according to the present invention.

The database 50 stores, in addition to the electricity tariff information and the predefined electricity utilization cost, the actual meter reading, and the actual electricity utilization cost for using the electricity consuming system 2 sent from the monitoring device 3 to the management platform 5′ via the network system 4′. In other words, the database 50 may store the electricity utilization status regarding the electricity consuming system 2 and the management status of the user to the electricity consuming system 2.

Furthermore, the analysis module 55 analyzes the electricity tariff information, the actual meter reading and electricity utilization cost, or the predefined electricity utilization cost stored in the database 50 to obtain an electricity utilization pattern. That is, the analysis module 55 analyzes the data in the database 50 to derive the utilization pattern of electricity consuming system 2 monitored by the monitoring device 3, for example, the patterns of the average daily/monthly meter readings indicating electrical utilization, daily/monthly electricity utilization curve over time, comparison of electricity utilization between this month and last month, time for maximum electricity utilization in a month/year, the relationship between the current electricity tariff and meter readings, and the analyzed result is stored in the database 50. In addition, the analysis module 55 can suggest an electricity management mechanism based on the current utilization pattern to the user, so as to achieve a more efficiently management by allowing the user 55 to get hold of the analysis result.

Moreover, the alerting module 56 sends out an alert if the actual electricity utilization cost of the electricity consuming system 2 is approaching the predefined electricity utilization cost. In addition, the alerting module 56 also sends out an alert if the electricity utilization status of the electricity consuming system 2 does not meet the safety requirements, such as in an event of stealing electricity, abnormal electricity utilization, or a substantial increase in current or power. More particularly, as the monitoring device 3 continuously monitors the electricity consuming system 2 and stores the actual electricity utilization cost obtained in the database 50, and the analysis module 55 also performs analysis of data stored in the database 50, such that the usual pattern of electricity utilization of the electricity consuming system 2 can be known. In addition, the user may also login to the management platform 5 via the Internet 6 and set a safety mode for electricity utilization. Once an abnormal status occurs in electricity utilization or the safety mode is violated for the electricity consuming system 2, the analysis module 55 instructs the alerting module 56 to send out an alert message, such as a SMS, a voice message, or e-mail to the users.

For example, the database 50 stores the average meter readings indicating electricity used per day or the actual electricity utilization curve per day, and the analysis module 55 analyzes the data of the electricity consuming system 2 monitored by the monitoring device 3 and finds that the electricity utilization curve deviates from the normal staircase-like behavior (e.g. the curve increases sharply, which may suggest that the stealing electricity occurs). In addition, the analysis module 55 and the alerting module 56 can work together. For example, when the analysis module 55 knows that there is abnormality in electricity utilization in the electricity consuming system 2, it instructs the alerting module 56 to send out an alert message to the user, and the monitoring device 3 waits a predetermine period of time before stopping the operation of the electricity consuming system 2 if this abnormality is not resolved.

In addition, the management platform 5′ of the intelligent administration system for paying electricity bills of the present invention may further include the display module 57 for displaying the electricity tariff information, the actual meter readings indicating electricity utilization of the electricity consuming system 2, the actual electricity utilization cost, the predefined electricity utilization cost, the paid amount, the balance, the electricity utilization pattern analyzed by the analysis module 55, e.g. the average daily/monthly meter readings, daily/monthly electricity utilization curve over time, comparison of electricity utilization between this month and last month, and the likes.

In summary, the intelligent administration system for paying electricity bills according to the present invention supervises the electricity utilization of the electricity consuming system and sends out alerts when the abnormality occurs or a predetermined value is exceeded. In addition, the administrator can adjust the charging standards according to the variations in the current electricity tariff, increasing flexibility for the system management; that is, the actual electricity utilization cost is calculated using the current electricity tariff so as to establish a fair and transparent intelligent administration system for paying electricity bills. Furthermore, the user can make prepayments via the management platform of the intelligent administration system for paying electricity bills of the present invention, and have the money deducted at the time of using electricity, achieve the goal of “user-pays”. Moreover, the management platform of the intelligent administration system for paying electricity bills can perform analysis on the data stored in the database and control the electricity utilization pattern of the electricity consuming system based on the analysis result.

Therefore, with the functions of various modules disclosed herein and the connections therebetween, the intelligent administration system for paying electricity bills of the present invention reduces the amount of work with respect to money handling, saving labor expense and increasing convenience of the users.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. An intelligent administration system for paying electricity bills, comprising:
a management platform including:
a tariff information module for setting electricity tariff information;
an electricity utilization preset module for presetting a predefined electricity utilization cost for an electricity consuming system; and
a transmission module for outputting the electricity tariff information and the predefined electricity utilization cost; and
a monitoring device for receiving the electricity tariff information and the predefined electricity utilization cost, and for monitoring actual meter readings indicating electricity consumption by the electricity consuming system so as to calculate an actual electricity utilization cost based on the electricity tariff information, and to thereby deactivate the electricity consuming system when the actual electricity utilization cost matches the predefined electricity utilization cost.

2. The intelligent administration system for paying electricity bills of claim 1, wherein the electricity tariff information is a current electricity tariff of a power company or a electricity tariff charging standard set by the intelligent administration system.

3. The intelligent administration system for paying electricity bills of claim 1, wherein the management platform further includes a paying module for allowing a user to login to the management platform and pay for the predefined electricity utilization cost.

4. The intelligent administration system for paying electricity bills of claim 1, wherein the monitoring device further transmits the actual meter readings or the actual electricity utilization cost to the management platform, and wherein the management platform further includes a database for storing the electricity tariff information, the predefined electricity utilization cost, the actual meter readings or the actual electricity utilization cost.

5. The intelligent administration system for paying electricity bills of claim 4, wherein the management platform further includes an analysis module for analyzing the electricity tariff information, the actual meter readings, the actual electricity utilization cost or the predefined electricity utilization cost.

6. The intelligent administration system for paying electricity bills of claim 5, wherein the management platform further includes an alerting module for sending out an alerting message when there is abnormality in an electricity consumption status of the electricity consuming system or the actual electricity utilization cost is approaching the predefined electricity utilization cost.

7. The intelligent administration system for paying electricity bills of claim 6, wherein the alerting message sent out by the alerting module is a text message, a voice message or an electronic mail.

8. The intelligent administration system for paying electricity bills of claim 1, wherein the management platform further includes a display module for displaying the electricity tariff information, the actual meter readings, the actual electricity utilization cost or the predefined electricity utilization cost.

9. The intelligent administration system for paying electricity bills of claim 1, wherein the management platform further connects to the Internet for allowing a user to login the management platform via the Internet to set the electricity tariff information by using the tariff information module, and allowing the user to login the management platform via the Internet to preset the predefined electricity utilization cost using the electricity utilization preset module.
